(19) United States
(12) Patent Application Publication
(10) Pub. No.: US 2026/0116263 A1
(43) Pub. Date: Apr. 30, 2026

(54) A METHOD FOR CONTROLLING A POWER SYSTEM OF A VEHICLE

(71) Applicant: VOLVO TRUCK CORPORATiON, Göteborg (SE)

(72) Inventor: Pranav ARYA, Lindome (SE)

(21) Appl. No.: 19/472,465

(22) PCT Filed: Apr. 4, 2023
(86) PCT No.: PCT/EP2023/058875

§ 371 Date: Oct. 3, 2025

(51) Int. Cl. B60L 58/40; B60L 58/13; B60L 58/16; H01M 8/04303; H01M 8/04858; H01M 8/04992; H01M 10/42; H01M 10/44; H01M 16/00

(52) U.S. Cl. CPC B60L 58/40; B60L 58/13; B60L 58/16; H01M 8/04303; H01M 8/04925; H01M 8/04992; H01M 10/425; H01M 10/44; H01M 16/006; B60L 2240/12; B60L 2240/26; B60L 2240/68; H01M 2220/20; H01M 2250/20; H01M 2250/402

(57) ABSTRACT

The present disclosure relates to a computer system and a method for controlling a power system of a vehicle. The power system includes a fuel cell system and an energy storage system including one or more batteries. The method includes: predicting a refuelling event during which the vehicle is expected to refuel a fuel tank of the fuel cell system at a fuelling station, estimating an instance for initiating a shutdown process of the fuel cell system, wherein after the estimated instance the vehicle is expected to be operated in a first operating mode, until an arrival to the fuelling station, and controlling the power system in a way such that the state-of-energy level of the energy storage system is equal to or higher than the determined state-of-energy threshold level when the vehicle reaches the estimated instance.

### TECHNICAL FIELD

The disclosure relates generally to control of a power system of a vehicle. In particular aspects, the disclosure relates to a computer-implemented method for controlling a power system which comprises a fuel cell system and an energy storage system. The disclosure also relates to a computer system, a computer program product, a control system, a non-transitory computer readable storage medium and a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In recent years, fuel cell systems have been considered as one of power sources for producing electric power in different applications, e.g., in fuel cell electric vehicles (FCEVs). Typically, a fuel cell system is used together with an energy storage system for providing electric power to various components of the fuel cell electric vehicle. The electric power may be used for powering one or more electric motors for creating a propulsion force to the vehicle.

FCEVs use hydrogen gas as fuel, which is usually fed to fuel cell stacks to react with oxygen for producing electricity. When a fuel level drops below a certain level, the FCEVs must be refueled at fuelling stations, e.g., at specialized hydrogen fuelling stations. During the refuelling process, fuel cell systems need to be temporarily shut down to ensure a safe and effective refuelling process.

### SUMMARY

According to a first aspect of the disclosure, a computer system comprising a processor device configured to control a power system of a vehicle according to claim 1 is provided. The power system comprises a fuel cell system and an energy storage system comprising one or more batteries, wherein the fuel cell system and the energy storage system are adapted to provide electric energy for powering the vehicle. The processor device is further configured to:
predict a refuelling event during which the vehicle is expected to refuel a fuel tank of the fuel cell system at a fuelling station,
estimate an instance for initiating a shutdown process of the fuel cell system, wherein after the estimated instance the vehicle is expected to be operated in a first operating mode, in which energy for powering the vehicle is at least partly supplied by the energy storage system and not by the fuel cell system, until an arrival to the fuelling station,
determine a state-of-energy threshold level of the energy storage system, the state-of-energy threshold level corresponding to a value of the state-of-energy of the energy storage system which is sufficient for the vehicle to travel from the estimated instance to the fuelling station in the first operating mode, and
control the power system in a way such that the state-of-energy level of the energy storage system is equal to or higher than the determined state-of-energy threshold level when the vehicle reaches the estimated instance.

The first aspect of the disclosure may seek to avoid a rapid shutdown of the fuel cell system at the fuelling station, which may lead to undesirable degradation of the fuel cell system. A technical benefit may include that unnecessary degradation of the fuel cell system may be avoided. According to the present disclosure, it is achieved by estimating an instance for initiating the shutdown process and ensuring a sufficient energy level in the energy storage system, such that the vehicle is able to travel from the estimated instance to the fuelling station whilst the fuel cell system is in a process of shutting down. In this way, the fuel cell system may be completely shut down before the arrival of the fuelling station.

By determining the state-of-energy threshold level and controlling the power system in a way such that the state-of-energy level of the energy storage system is equal to or higher than the determined state-of-energy threshold level, it may be possible to ensure the above-mentioned sufficient energy level. This may reduce a risk of the energy storage system running out of energy during the travel to the fuelling station, and therefore may mitigate a risk of fuel cell system being forced to turn on again to provide energy or to charge batteries of the energy storage system. As such, unnecessary degradation of the fuel cell system may further be avoided due to the factor that frequently turning on and off the fuel cell system may accelerate an ageing process of the fuel cell stacks of the fuel cell system.

Herein, the ‘first operating mode’ corresponds to a mode in which energy for powering the vehicle is not provided by the fuel cell system. Purely by way of example, it may refer to a Battery Electric Vehicle (BEV) mode where the energy is solely supplied by electric batteries of the energy storage system. In some other examples, the energy may be supplied by the electric batteries as well as other power sources, e.g., a supercapacitor.

The term ‘instance for initiating a shutdown of the fuel cell system’ may be understood as an instance, associated with a time and/or a position, that the processor triggers the initiation of the shutdown process. It may define when to or where to initiate the shutdown of the fuel cell system.

According to a second aspect of the disclosure, a computer-implemented method for controlling a power system of a vehicle by a processor device of a computer system according to claim 2 is provided. The power system comprises a fuel cell system and an energy storage system comprising one or more batteries, wherein the fuel cell system and the energy storage system are adapted to provide electric power for powering the vehicle, the method comprising:
predicting, by the processor device, a refuelling event during which the vehicle is expected to refuel a fuel tank of the fuel cell system at a fuelling station,
estimating, by the processor device, an instance for initiating a shutdown process of the fuel cell system, wherein after the estimated instance the vehicle is expected to be operated in a first operating mode, in which energy for powering the vehicle is at least partly supplied by the energy storage system and not by the fuel cell system, until an arrival to the fuelling station,
determining, by the processor device, a state-of-energy threshold level of the energy storage system, the state-of-energy threshold level corresponding to a value of the state-of-energy of the energy storage system which is sufficient for the vehicle to travel from the estimated instance to the fuelling station in the first operating mode, and
controlling, by the processor device, the power system in a way such that the state-of-energy level of the energy storage system is equal to or higher than the determined state-of-energy threshold level when the vehicle reaches the estimated instance.

Advantages and technical benefits of the second aspect of the disclosure are largely analogous to the advantages and technical benefits of the first aspect of the disclosure. It shall also be noted that all examples of the second aspect of the disclosure are combinable with all embodiments of the first aspect of the disclosure, and vice versa.

The computer-implemented method as disclosed herein may be performed in the processor device, such as in one or more electronic control units. The processor device may comprise a computing unit for estimating the instance for initiating a shutdown of the fuel cell system and/or for determining the state-of-energy threshold level. The processor device may further comprise a communicating unit for communicating the initiation of the shutdown process with the fuel cell system.

In some examples, including in at least one preferred example, optionally, the method further comprises using a first instance to define a first instance limit, wherein the initiation of the shutdown process of the fuel cell system is triggered after the first instance limit. A technical benefit may include that a premature shutdown of the fuel cell system may be avoided.

In some examples, including in at least one preferred example, optionally, the first instance corresponds to a first time point or a first position point in relation to the fuelling station.

In some examples, including in at least one preferred example, optionally, the first time point is associated with an earliest possible time point for initiating the shutdown process of the fuel cell system, from which the vehicle is able to travel to the fuelling station in the first operating mode if the energy storage system is charged to a maximum allowable state-of-energy level, or wherein the first position point is associated with a furthest possible position point away from the fuelling station for initiating the shutdown of the fuel cell system, from which the vehicle is able to travel to the fuelling station in the first operating mode if the energy storage system is charged to a maximum allowable state-of-energy level.

By using the first time point associated with an earliest possible time point or the first position point associated with a furthest possible position point away from the fuelling station to define a first instance limit, it may be possible to avoid a premature shutdown. In particular, it may be possible to avoid initiating the shutdown process too early such that the state-of-energy level of the energy storage system is lower than the determined state-of-energy threshold level at that time. As a result, a risk of the fuel cell system being forced to turn on again to provide energy or to charge batteries of the energy storage system during the travelling to the fuelling station may be reduced. A technical benefit may include that unnecessary degradation of the fuel cell system may be avoided. Furthermore, an appropriate instance for initiating the shutdown process may therefore be estimated, such that there is sufficient energy for the vehicle to travel from the estimated instance to the fuelling station in the first operating mode.

In some examples, including in at least one preferred example, optionally, the method further comprises using a second instance to define a second instance limit, wherein the initiation of the shutdown process of the fuel cell system is triggered before the second instance limit. A technical benefit may include that a belated shutdown of the fuel cell system may be avoided.

In some examples, including in at least one preferred example, optionally, the second instance corresponds to a second time point or a second position point in relation to the fuelling station.

In some examples, including in at least one preferred example, optionally, the second time point is associated with a latest possible time point for initiating the shutdown of the fuel cell system, or wherein the second position point is associated with a closest possible position point away from the fuelling station for initiating the shutdown process of the fuel cell system, such that the fuel cell system is completely shut down before the arrival to the fuelling station.

By using the second time point associated with a latest possible time point or the second position point associated with a closest possible position point away from the fuelling station to define the second instance limit, it may be possible to avoid a belated shutdown of the fuel cell system. In particular, it may be possible to avoid a scenario where the shutdown process is initiated too late such that the fuel cell system is not completely shut down when arriving at the fuelling station, which may cause unnecessary waiting time at the fuelling station. A technical benefit may include that the refuelling of the fuel tank may be performed in an efficient way.

In some examples, including in at least one preferred example, optionally, estimating the instance for initiating a shutdown process of the fuel cell system comprises determining a preferred instance within the first instance limit and the second instance limit, wherein the preferred instance is determined based on a degradation factor of the fuel cell system and/or of the energy storage system. In this way, an appropriate instance for initiating the shutdown of the fuel cell system may be determined. Specifically, initiating the shutdown process early may allow for more time to cool down various components of the fuel cell system, such as the fuel cell stacks. As a result, the fuel cell system's temperature may be within a desirable range after the refuelling event and the system may be better prepared for a subsequent driving event. However, this may in turn increase a workload for the energy storage system and may thereby accelerate an aging of the energy storage system. The preferred instance may be determined based on the degradation factor, which may take the above factors into consideration, such that the degradation of the fuel cell system and of the energy storage system is balanced. A technical benefit may include that the degradation of the power system may be reduced.

In some examples, including in at least one preferred example, optionally, the method further comprises starting a shutdown process of the fuel cell system at the estimated instance.

In some examples, including in at least one preferred example, optionally, the method further comprises switching a vehicle operating mode to the first operating mode at the estimated instance.

In some examples, including in at least one preferred example, optionally, the instance for initiating the shutdown process of the fuel cell system is estimated based on at least one of a time duration for shutting down the fuel cell system, fuelling station location information, a current vehicle speed, a vehicle weight, a maximum allowable state-of-energy level of the energy storage system and information about the route that the vehicle is currently travelling on including at least one of terrain information, speed limit information, and traffic information. In this way, a more accurate instance may be estimated by taking various parameters into consideration. A technical benefit may include an improved estimation of the instance for initiating the shutdown of the fuel cell system.

In some examples, including in at least one preferred example, optionally, the maximum allowable state-of-energy level of the energy storage system is dependent on a capacity of the energy storage system as well as a current fuel level of the fuel tank. As such, the parameter of the maximum allowable state-of-energy level of the energy storage system may not only consider its physical capacity limit, but may also consider a current power level of the fuel cell system. For instance, when the current power level of the fuel cell system is too low to charge the electric batteries of the energy storage system to its physical maximum allowable limit due to a low amount of available fuel, the maximum allowable state-of-energy level may in this situation be dependent on the current fuel level of the fuel tank. In this way, the parameter is adapted to a real-time situation and a more accurate instance may therefore be estimated. A technical benefit may include an improved estimation of the instance for initiating the shutdown of the fuel cell system.

In some examples, including in at least one preferred example, optionally, the time duration for shutting down the fuel cell system is dependent on the process of shutting down the fuel cell system, and/or a power level at which the fuel cell system is running at the estimated instance and/or ambient temperature, wherein the process comprises a plurality of steps, preferably including disconnecting air supply and fuel supply to fuel cell stacks, disconnecting electric loads with the fuel cell system and conditioning components of the fuel cell system. As such, the parameter of time duration for shutting down the fuel cell system may be estimated in a more accurate way. In particular, it may ensure that sufficient time is estimated such that the shutdown process, including all the steps, are completely finished before the arrival to the fuelling station. A technical benefit may include an improved estimation of the instance for initiating the shutdown of the fuel cell system.

Herein, ‘the process of shutting down the fuel cell system’ may be understood as a normal shutdown process, which may be performed by a step-by-step process. Purely by way of example, the step may be disconnecting air supply and fuel supply to fuel cell stacks, or disconnecting electric loads with the fuel cell system or conditioning components of the fuel cell system. This is as opposed to a rapid shutdown process, which aims to shut down the fuel cell system as soon as possible, typically taking 1 to 5 seconds to complete the whole process. During the rapid shutdown process, fuel cell components may not be conditioned properly, which may cause unwanted degradation of the fuel cell system.

In some examples, including in at least one preferred example, optionally, controlling the power system in a way such that the state-of-energy level of the energy storage system is equal to or higher than the determined state-of-energy threshold level when the vehicle reaches the estimated instance comprises temporarily increasing a power output from the fuel cell system and charging the energy storage system by use of the power from the fuel cell system. A technical benefit may include that a risk of energy storage system running out of energy during the travel to the fuelling station is mitigated.

In some examples, including in at least one preferred example, optionally, the prediction of the refuelling event is based on at least one of current fuel level of the fuel tank, an estimated fuel consumption and information about available fuelling stations along the route that the vehicle is currently travelling on. As such, a more accurate prediction may be achieved by taking various parameters into consideration and a technical benefit may include an improved prediction of the refuelling event.

According to a third aspect of the disclosure, a computer program product comprising program code for performing the method according to the second aspect of the disclosure is provided.

According to a fourth aspect of the disclosure, a control system comprising one or more control units configured to perform the method according to the second aspect of the disclosure is provided.

According to a fifth aspect of the disclosure, a non-transitory computer-readable storage medium comprising instructions is provided. The non-transitory computer-readable storage medium comprises instructions, which when executed by the processor device, cause the processor device to perform the method according to the second aspect of the disclosure.

According to a sixth aspect of the disclosure, a vehicle comprising a power system adapted to provide electric power for one or more energy consumers of the vehicle is provided. The vehicle further comprises the computer system according to the first aspect of the disclosure and/or the control system according to the fourth aspect of the disclosure.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a schematic side view of an exemplary vehicle comprising a power system according to an aspect of the disclosure.

FIG. 2 is a flowchart illustrating an exemplary method of controlling the power system shown in FIG. 1.

FIG. 3 is a graph showing an exemplary scenario when a vehicle is approaching a fuelling station.

FIG. 4 is another flowchart illustrating an exemplary method of operating a power system, in accordance with the exemplary scenario shown in FIG. 3.

FIG. 5 is a schematic diagram of an exemplary computer system for implementing examples disclosed herein, according to one example.

The drawings are schematic and not necessarily drawn to scale.

### DETAILED DESCRIPTION

The detailed description set forth below provides information and examples of the disclosed technology with sufficient detail to enable those skilled in the art to practice the disclosure.

When refuelling a fuel tank at a fuelling station, a fuel cell system needs to be temporarily shut down to ensure a safe and effective refuelling process. The fuel cell system may need to be shut down in a fast manner to begin the refuelling process. Generally, a rapid shutdown process aims to turn off the fuel cell system as soon as possible, and as a result, fuel cell components may not be conditioned properly before the shutdown. This may lead to unnecessary degradation of the fuel cell system. The present disclosure may seek to avoid the rapid shutdown of the fuel cell system at the fuelling station. A technical benefit of the present disclosure may include that unnecessary degradation of the fuel cell system may be avoided.

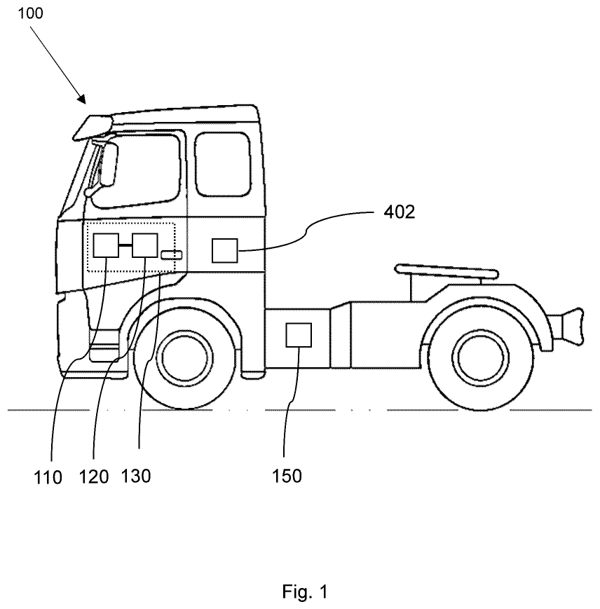

FIG. 1 depicts a vehicle 100, which is exemplified by a fuel cell electric truck. Even though a fuel cell electric truck is shown, it shall be noted that the disclosure is not limited to this type of vehicle, but it may also be used for other electric vehicles, such as a bus, construction equipment, e.g., a wheel loader or an excavator.

The vehicle 100 comprises a power system 130. The power system 130 further comprises a fuel cell system 110 and an energy storage system 120 comprising one or more batteries which are adapted to provide electric power. The electric power is configured to be fed to one or more electric motors to create a propulsion force for propelling the vehicle 100. The electric power provided by the fuel cell system 110 may also be used to charge the one or more batteries of the energy storage system 120. In some examples, the power system 130 may further comprise more power sources to provide electric power, e.g., a supercapacitor. The vehicle 100 may be operated in different operating modes. For instance, it may be operated in a hybrid mode in which energy for powering the vehicle 100 is supplied by the fuel cell system 110 as well as the energy storage system 120. Alternately, it may be operated in a BEV mode in which energy for powering the vehicle 100 is solely provided from batteries of the energy storage system 120. In yet another example, the vehicle 100 may be operated in an operating mode in which energy for powering the vehicle 100 is at least partly supplied by the energy storage system 120 and not by the fuel cell system 110.

The vehicle 100 further comprises a control system 402. The control system 402 may comprise one or more control units, which may also be referred to as one or more processor devices 402. The one or more processor devices 402 may be configured to control the power system 130 using a method according to an example of the disclosure. The vehicle 100 may further comprise a navigation system (not shown). The navigation system may comprise one or more sensors, e.g., a global positioning system (GPS) sensor, configured to position the vehicle 100 on a road that it is currently travelling on.

The vehicle 100 further comprises a fuel tank 150 that stores fuel, typically hydrogen fuel. When a fuel level in the fuel tank 150 falls below a certain level, the vehicle 100 needs to go to a fuelling station to refill the fuel tank 150. During the refuelling process, the fuel cell system 110 needs to be temporarily shut down to ensure a safe and effective refuelling process.

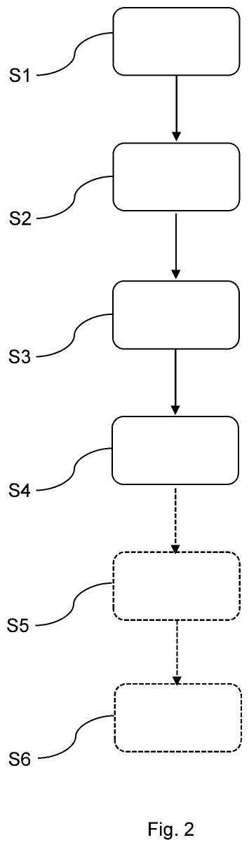

FIG. 2 is a flowchart illustrating an exemplary method of controlling the power system 130. The method may be applied to any type of fuel cell electric vehicles, e.g., the truck 100 shown in FIG. 1. The method may be performed by the processor device 402 shown in FIG. 1. The method comprises the steps listed in the following, which, unless otherwise indicated, may be taken in any suitable order.
S1: predicting a refuelling event during which the vehicle 100 is expected to refuel a fuel tank 150 of the fuel cell system at a fuelling station 200. The prediction may be based on at least one of the following information: a current fuel level of the fuel tank 150, an estimated fuel consumption and any available fuelling stations along the route that the vehicle 100 is currently travelling on. Various vehicle sensors may be configured to gather the above information and to report the information to the processor device 402.
S2: estimating, an instance for initiating a shutdown process of the fuel cell system 110, wherein after the estimated instance the vehicle 100 is expected to be operated in a first operating mode, in which energy for powering the vehicle 100 is at least partly supplied by the energy storage system 120 and not by the fuel cell system 110, until an arrival to the fuelling station 200. In some examples, the first mode may refer to a Battery Electric Vehicle (BEV) mode where the energy is solely supplied by electric batteries of the energy storage system 120. In some other examples, the energy may be supplied by the electric batteries as well as other power sources, e.g., a supercapacitor.

In some examples, the method may comprise an optional step S2-1: using a first instance to define a first instance limit, wherein the initiation of the shutdown process of the fuel cell system 110 is triggered after the first instance limit. The first instance may correspond to a first time point or a first position point in relation to the fuelling station 200. In some examples, the first time point may be associated with an earliest possible time point for initiating the shutdown of the fuel cell system 110, from which the vehicle 100 is able to travel to the fuelling station 200 in the first operating mode if the energy storage system 120 is charged to a maximum allowable state-of-energy level, or is associated with a furthest possible position point away from the fuelling station 200 for initiating the shutdown processor of the fuel cell system 110, from which the vehicle 100 is able to travel to the fuelling station 200 in the first operating mode if the energy storage system 120 is charged to a maximum allowable state-of-energy level. In this way, it may be possible to avoid a premature shutdown. In particular, it may be possible to avoid initiating the shutdown process too early such that the state-of-energy level of the energy storage system is lower than the determined state-of-energy threshold level at that time. As a result, a risk of fuel cell system 110 being forced to turn on again to provide energy or to charge the one or more batteries of the energy storage system 120 during the travel to the fuelling station 200 may be reduced. Furthermore, an appropriate instance for initiating the shutdown process may therefore be estimated, such that there is sufficient energy for the vehicle 100 to travel from the estimated instance to the fuelling station 200 in the first operating mode.

In some examples, the method may comprise an optional step S2-2: using a second instance to define a second instance limit, wherein the initiation of the shutdown process of the fuel cell system 110 is triggered before the second instance limit. The second instance may correspond to a second time point or a second position point in relation to the fuelling station 200. In some examples, the second time point is associated with a latest possible time point for initiating the shutdown process of the fuel cell system 100, or is associated with a closest possible position point away from the fuelling station 200 for initiating the shutdown process of the fuel cell system 110, such that the fuel cell system 110 is completely shut down before the arrival to the fuelling station 200. In this way, it may be possible to avoid a belated shutdown of the fuel cell system 110. In particular, it may be possible to avoid a scenario where the shutdown process is initiated too late such that the fuel cell system 110 is not completely shut down when arriving at the fuelling station 200, which may cause unnecessary waiting time at the fuelling station 200.

In some examples, the method may comprise an optional step S2-3: determining a preferred instance within the first instance limit and the second instance limit, wherein the preferred instance is determined based on a degradation factor of the fuel cell system 110 and/or of the energy storage system 120. Generally, initiating the shutdown process earlier allows for more time to cool down various components of the fuel cell system 110, such as the fuel cell stacks. As a result, the fuel cell system's temperature may be within a desirable range after the refuelling event and the fuel cell system 110 may be better prepared for a subsequent driving event. However, this may in turn increase a workload for the energy storage system 120 and may thereby accelerate an aging of the energy storage system 120. The processor device 402 may determine the preferred instance based on the degradation factor, which may take the above factors into consideration, such that the degradation of the fuel cell system 110 and of the energy storage system 120 is balanced.

In some examples, the instance for initiating a shutdown process the fuel cell system 110 is estimated based on at least one of a time duration for shutting down the fuel cell system 110, refuelling station 200 location information, a current vehicle speed, a vehicle weight, a maximum allowable state-of-energy level of the energy storage system 120 and information about the route that the vehicle 100 is currently travelling on including at least one of terrain information, speed limit information, and traffic information. Various vehicle sensors may be configured to gather the above information and to report the information to the processor device 402.

The time duration for shutting down the fuel cell system 110 may be dependent on the process of shutting down the fuel cell system 110, and/or a power level at which the fuel cell system 110 is running at the estimated instance and/or ambient temperature, wherein the process may comprise a plurality of steps, preferably including disconnecting air supply and fuel supply to fuel cell stacks, disconnecting electric loads with the fuel cell system 110 and conditioning components of the fuel cell system 110. In this way, it may be possible to ensure that sufficient time is estimated such that the shutdown process, including all the steps, are completely finished before the arrival to the fuelling station 200. Here, ‘the process of shutting down the fuel cell system’ may refer to a normal shutdown process, which may be performed by a step-by-step process. Purely by way of example, the step may comprise disconnecting air supply and fuel supply to fuel cell stacks or disconnecting electric loads with the fuel cell system 110 or conditioning components of the fuel cell system 110. This is as opposed to a rapid shutdown process, typically taking 1 to 5 seconds to complete the whole process. During the rapid shutdown process, fuel cell components may not be conditioned properly, which may cause increased degradation of the fuel cell system 110.

The maximum allowable state-of-energy level of the energy storage system 120 may be dependent on a capacity of the energy storage system 120 as well as a current fuel level of the fuel tank 150. As such, the parameter of the maximum allowable state-of-energy level of the energy storage system 120 may not only consider its physical capacity limit, but may also consider a current available power level of the fuel cell system 110. For instance, when the current power level of the fuel cell system 110 is too low to charge batteries of the energy storage system 120 to its physical maximum allowable limit due to a low amount of available fuel, the maximum allowable state-of-energy level may instead in this situation be dependent on the current fuel level of the fuel tank 150. In this way, the parameter is adapted to a real-time situation and a more accurate instance may therefore be estimated.

The method further comprises S3: determining a state-of-energy threshold level of the energy storage system 120, the state-of-energy threshold level corresponding to a value of the state-of-energy of the energy storage system 120 which is sufficient for the vehicle 100 to travel from the estimated instance to the fuelling station 200 in the first operating mode.

In response to the determined state-of-energy threshold level, the processor device will perform S4: controlling the power system 130 in a way such that the state-of-energy level of the energy storage system 120 is equal to or higher than the determined state-of-energy threshold level when the vehicle 100 reaches the estimated instance. In this way, it may be possible to ensure a sufficient energy level in the energy storage system 120, such that the vehicle 100 is able to travel from the estimated instance to the fuelling station 200 whilst the fuel cell system 110 is in a process of shutting down. The fuel cell system 100 may be completely shut down before the arrival of the fuelling station 200.

In some examples, controlling the power system 130 in a way such that the state-of-energy level of the energy storage system 120 is equal to or higher than the determined state-of-energy threshold level when the vehicle 100 reaches the estimated instance may comprise S4-1: increasing a power output from the fuel cell system 110 and charging the energy storage system 120 by use of the power from the fuel cell system 110.

In some examples, the method may further comprise S5: starting a shutdown process of the fuel cell system 110 at the estimated instance

In some examples, the method may further comprise S6: switching a vehicle operating mode to the first operating mode at the estimated instance.

S5 and S6 are shown in FIG. 2 by boxes with dashed lines, meaning that the actions are optional. The optional steps S2-1, S2-2, S2-3 and S4-1 are however not shown in the figure. They may be understood as sub steps under S2 and S4 respectively.

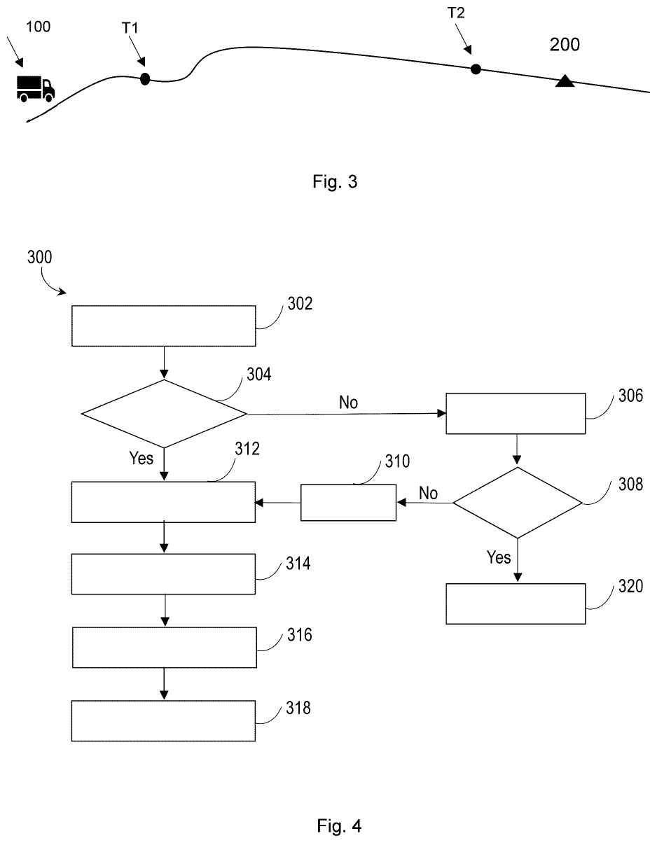

FIG. 3 is a graph showing an exemplary scenario when a vehicle 100 is approaching a fuelling station 200, and FIG. 4 shows another flowchart illustrating a process 300 of operating the power system 130 when the vehicle 100 encounters the scenario shown in FIG. 3.

The process 300 includes acts or steps of the exemplary method shown in FIG. 2. Therefore, the detailed description of the steps is not repeated.

The process 300 comprises the following blocks:
Block 302: approaching a fuelling station. At this block, the vehicle 100 is approaching a fuelling station 200 as shown in FIG. 3. The navigation system may provide necessary information about the fuelling station 200 and may report to the processor device 402. Meanwhile, the processor device 402 may collect all the related information, described in paragraph [0049] and paragraph [0054], from various vehicle sensors.
Block 304: is refueling scheduled at this station? At this block, the processor device 402 may verify whether a refuelling event has been scheduled at this fuelling station 200.
Block 312: determining a preferred instance for initiating a shutdown of the fuel cell system. In response to verifying that a refuelling event has been scheduled at the fuelling station 200 (Yes), the processor device 402 may determine a preferred instance for initiating a shutdown process of the fuel cell system 110. As mentioned in Step S2-3, the preferred instance may be within a first instance limit and a second instance limit. In FIG. 3, the instance limits are exemplified by time points and there is a first instance limit T1 and a second instance limit T2. T1 may be associated with an earliest possible time point for initiating the shutdown process and T2 may be associated with a latest possible time point. The preferred instance may lie within a time window defined by T1 and T2.
Block 314: determining a state-of-energy threshold level of the energy storage system. This step is similar to S3 in FIG. 2.
Block 316: controlling the power system in a way such that the state-of-energy level of the energy storage system is equal to or higher than the determined state-of-energy threshold level. This step is similar to S4 in FIG. 2.
Block 318: starting a shutdown process for the fuel cell system at the determined preferred instance. This step is similar to S5 in FIG. 2.
Block 306: checking a current fuel level in the fuel tank. In response to verifying that a refuelling event has not been scheduled at the fuelling station 200 (No), the processor device 402 may check the current fuel level in the fuel tank 150.
Block 308: is current fuel level sufficient for the vehicle to travel to the next fuelling station. At this block, the processor device 402 may verify whether the current amount of fuel is sufficient for the vehicle 100 to travel to the next fuelling station.
Block 310: suggesting refuelling the fuel tank at the fuelling station. In response to verifying that there is not sufficient fuel in the fuel tank 150 (No), the processor device 402 may suggest a driver to refuel the fuel tank 150 at the fuelling station 200. The processor device 402 may then perform the step in Block 312.
Block 320: end of the process. In response to verifying that the fuel is sufficient for the vehicle 100 to travel to the next fuelling station (Yes), the processor device 402 may end the process 300.

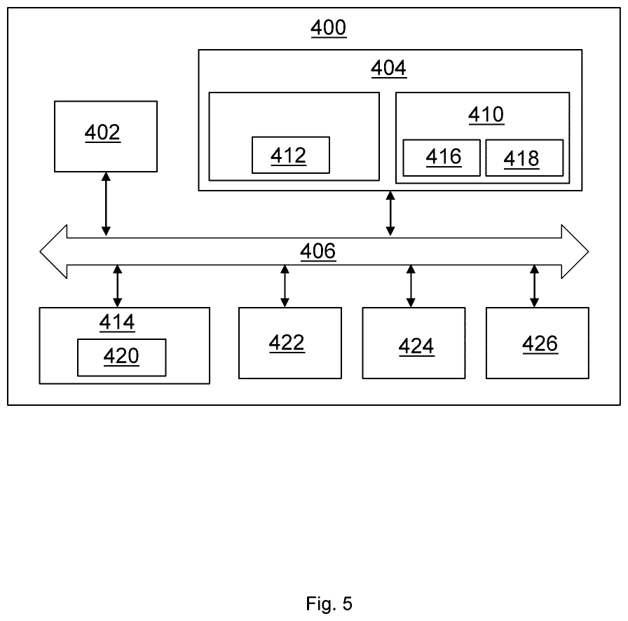

The disclosure also relates to a computer system 400, as e.g. shown in FIG. 5. The computer system 400 comprises a processor device 402 configured to control a power system 130 of a vehicle 100, the power system 130 comprising a fuel cell system 110 and an energy storage system 120 comprising one or more batteries, wherein the fuel cell system 110 and the energy storage system 120 are adapted to provide electric energy for powering the vehicle 100, the processor device 402 further being configured to:
predict a refuelling event during which the vehicle 100 is expected to refuel a fuel tank 150 of the fuel cell system 110 at a fuelling station 200,
estimate an instance for initiating a shutdown process of the fuel cell system 110, wherein after the estimated instance the vehicle 100 is expected to be operated in a first operating mode, in which energy for powering the vehicle 100 is at least partly supplied by the energy storage system 120 and not by the fuel cell system 110, until an arrival to the fuelling station 200,
determine a state-of-energy threshold level of the energy storage system 120, the state-of-energy threshold level corresponding to a value of the state-of-energy of the energy storage system 120 which is sufficient for the vehicle 100 to travel from the estimated instance to the fuelling station 200 in the first operating mode, and
control the power system 130 in a way such that the state-of-energy level of the energy storage system 120 is equal to or higher than the determined state-of-energy threshold level when the vehicle 100 reaches the estimated instance.

The computer system 400 may comprise at least one computing device or electronic device capable of including firmware, hardware, and/or executing software instructions to implement the functionality described herein. The computer system 400 may include one or more electronic control units 402, such as the control unit 402 illustrated in FIG. 1, which may also be referred to as a processor device, a memory 404, and a system bus 406. The computer system 400 may include at least one computing device having the control unit 402. The system bus 406 provides an interface for system components including, but not limited to, the memory 404 and the control unit 402. The control unit 402 may include any number of hardware components for conducting data or signal processing or for executing computer code stored in memory 404. The control unit 402 (e.g., processor device) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The control unit may further include computer executable code that controls operation of the programmable device.

The system bus 406 may be any of several types of bus structures that may further interconnect to a memory bus (with or without a memory controller), a peripheral bus, and/or a local bus using any of a variety of bus architectures. The memory 404 may be one or more devices for storing data and/or computer code for completing or facilitating methods described herein. The memory 404 may include database components, object code components, script components, or other types of information structure for supporting the various activities herein. Any distributed or local memory device may be utilized with the systems and methods of this description. The memory 404 may be communicably connected to the control unit 402 (e.g., via a circuit or any other wired, wireless, or network connection) and may include computer code for executing one or more processes described herein. The memory 404 may include non-volatile memory 408 (e.g., read-only memory (ROM), erasable programmable read-only memory (EPROM), electrically erasable programmable read-only memory (EEPROM), etc.), and volatile memory 410 (e.g., random-access memory (RAM)), or any other medium which can be used to carry or store desired program code in the form of machine-executable instructions or data structures and which can be accessed by a computer or other machine with a control unit 402. A basic input/output system (BIOS) 412 may be stored in the non-volatile memory 408 and can include the basic routines that help to transfer information between elements within the computer system 400.

The computer system 400 may further include or be coupled to a non-transitory computer-readable storage medium such as the storage device 414, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 414 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 414 and/or in the volatile memory 410, which may include an operating system 416 and/or one or more program modules 418. All or a portion of the examples disclosed herein may be implemented as a computer program product 420 stored on a transitory or non-transitory computer-usable or computer-readable storage medium (e.g., single medium or multiple media), such as the storage device 414, which includes complex programming instructions (e.g., complex computer-readable program code) to cause the control unit 402 to carry out the steps described herein. Thus, the computer-readable program code can comprise software instructions for implementing the functionality of the examples described herein when executed by the control unit 402. The control unit 402 may serve as a controller or control system for the computer system 400 that is to implement the functionality described herein, such as for the control system 4 illustrated in FIG. 2.

The computer system 400 also may include an input device interface 422 (e.g., input device interface and/or output device interface). The input device interface 422 may be configured to receive input and selections to be communicated to the computer system 400 when executing instructions, such as from a keyboard, mouse, touch-sensitive surface, etc. Such input devices may be connected to the processor device 402 through the input device interface 422 coupled to the system bus 406 but can be connected through other interfaces such as a parallel port, an Institute of Electrical and Electronic Engineers (IEEE) 1394 serial port, a Universal Serial Bus (USB) port, an IR interface, and the like. The computer system 400 may include an output device interface 424 configured to forward output, such as to a display, a video display unit (e.g., a liquid crystal display (LCD) or a cathode ray tube (CRT)). The computer system 400 may also include a communications interface 426 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1-20. (canceled)

21. A computer system comprising a processor device configured to control a power system of a vehicle, the power system comprising a fuel cell system and an energy storage system comprising one or more batteries, wherein the fuel cell system and the energy storage system are adapted to provide electric energy for powering the vehicle, the processor device further being configured to:
predict a refuelling event during which the vehicle is expected to refuel a fuel tank of the fuel cell system at a fuelling station,
estimate an instance, associated with a time and/or a position, for initiating a shutdown process of the fuel cell system, wherein after the estimated instance the vehicle is expected to be operated in a first operating mode, in which energy for powering the vehicle is at least partly supplied by the energy storage system and not by the fuel cell system, until an arrival to the fuelling station, wherein the processor device is further configured to:
determine a state-of-energy threshold level of the energy storage system, the state-of-energy threshold level corresponding to a value of the state-of-energy of the energy storage system which is sufficient for the vehicle to travel from the estimated instance to the fuelling station in the first operating mode, and
control the power system in a way such that the state-of-energy level of the energy storage system is equal to or higher than the determined state-of-energy threshold level when the vehicle reaches the estimated instance,
wherein control the power system in a way such that the state-of-energy level of the energy storage system is equal to or higher than the determined state-of-energy threshold level when the vehicle reaches the estimated instance comprises temporarily increasing a power output from the fuel cell system and charging the energy storage system by use of the power from the fuel cell system.

22. A computer-implemented method for controlling a power system of a vehicle, by a processor device of a computer system, said power system comprising a fuel cell system and an energy storage system comprising one or more batteries, wherein the fuel cell system and the energy storage system are adapted to provide electric power for powering the vehicle, the method comprising:
predicting, by the processor device, a refuelling event during which the vehicle is expected to refuel a fuel tank of the fuel cell system at a fuelling station,
estimating, by the processor device, an instance, associated with a time and/or a position, for initiating a shutdown process of the fuel cell system, wherein after the estimated instance the vehicle is expected to be operated in a first operating mode, in which energy for powering the vehicle is at least partly supplied by the energy storage system and not by the fuel cell system, until an arrival to the fuelling station wherein the method further comprises:
determining, by the processor device, a state-of-energy threshold level of the energy storage system, the state-of-energy threshold level corresponding to a value of the state-of-energy of the energy storage system which is sufficient for the vehicle to travel from the estimated instance to the fuelling station in the first operating mode, and
controlling, by the processor device, the power system in a way such that the state-of-energy level of the energy storage system is equal to or higher than the determined state-of-energy threshold level when the vehicle reaches the estimated instance.
wherein controlling the power system in a way such that the state-of-energy level of the energy storage system is equal to or higher than the determined state-of-energy threshold level when the vehicle reaches the estimated instance comprises temporarily increasing a power output from the fuel cell system and charging the energy storage system by use of the power from the fuel cell system.

23. The method according to claim 22, wherein the method further comprises using a first instance to define a first instance limit, wherein the initiation of the shutdown process of the fuel cell system is triggered after the first instance limit.

24. The method according to claim 23, wherein the first instance corresponds to a first time point or a first position point in relation to the fuelling station.

25. The method according to claim 24, wherein the first time point is associated with an earliest possible time point for initiating the shutdown process of the fuel cell system, from which the vehicle is able to travel to the fuelling station in the first operating mode if the energy storage system is charged to a maximum allowable state-of-energy level, or wherein the first position point is associated with a furthest possible position point away from the fuelling station for initiating the shutdown of the fuel cell system, from which the vehicle is able to travel to the fuelling station in the first operating mode if the energy storage system is charged to a maximum allowable state-of-energy level.

26. The method according to claim 22, wherein the method further comprises using a second instance to define a second instance limit, wherein the initiation of the shutdown process of the fuel cell system is triggered before the second instance limit.

27. The method according to claim 26, wherein the second instance corresponds to a second time point or a second position point in relation to the fuelling station.

28. The method according to claim 27, wherein the second time point is associated with a latest possible time point for initiating the shutdown of the fuel cell system, or wherein the second position point is associated with a closest possible position point away from the fuelling station for initiating the shutdown of the fuel cell system, such that the fuel cell system is completely shut down before the arrival to the fuelling station.

29. The method according to claim 26, wherein estimating the instance for initiating a shutdown process of the fuel cell system comprises determining a preferred instance within the first instance limit and the second instance limit, wherein the preferred instance is determined based on a degradation factor of the fuel cell system and/or of the energy storage system.

30. The method according to claim 22, wherein the method further comprises starting the shutdown process of the fuel cell system at the estimated instance.

31. The method according to claim 22, wherein the method further comprises switching a vehicle operating mode to the first operating mode at the estimated instance.

32. The method according to claim 22, wherein the instance for initiating the shutdown process of the fuel cell system is estimated based on at least one of a time duration for shutting down the fuel cell system, refuelling station location information, a current vehicle speed, a vehicle weight, a maximum allowable state-of-energy level of the energy storage system and information about the route that the vehicle is currently travelling on including at least one of terrain information, speed limit information, and traffic information.

33. The method according to claim 32, where the maximum allowable state-of-energy level of the energy storage system is dependent on a capacity of the energy storage system as well as a current fuel level of the fuel tank.

34. The method according to claim 32, wherein the time duration for shutting down the fuel cell system is dependent on the process of shutting down the fuel cell system, and/or a power level at which the fuel cell system is running at the estimated instance and/or ambient temperature, wherein the shutdown process comprises a plurality of steps, preferably including disconnecting air supply and fuel supply to fuel cell stacks, disconnecting electric loads with the fuel cell system and conditioning components of the fuel cell system.

35. The method according to claim 22, wherein the prediction of the refuelling event is based on at least one of current fuel level of the fuel tank, an estimated fuel consumption and information about available fuelling stations along the route that the vehicle is currently travelling on.

36. A computer program product comprising program code for performing, when executed by the processor device, the method of claim 22.

37. A control system comprising one or more control units configured to perform the method of claim 22.

38. A non-transitory computer-readable storage medium comprising instructions, which when executed by the processor device, cause the processor device to perform the method of claim 22.

39. A vehicle comprising a power system adapted to provide electric power for powering the vehicle, and further comprising the computer system according to claim 21.
